(19) United States
(12) Patent Application Publication
(10) Pub. No.: US 2025/0168555 A1
(43) Pub. Date: May 22, 2025

(54) AGRICULTURAL VEHICLE CONTROL SYSTEMS AND METHODS USING AUDIO SIGNALS FROM MICROPHONES

(71) Applicant: Raven Industries, Inc., Sioux Falls, SD (US)

(72) Inventors: Jared Ernest Kocer, Sioux Falls, SD (US); Christopher Richard Wiegman, Oak Lawn, IL (US)

(21) Appl. No.: 18/948,690

(22) Filed: Nov. 15, 2024

Related U.S. Application Data
(60) Provisional application No. 63/599,833, filed on Nov. 16, 2023.

(51) Int. Cl. H04R 1/32

(52) U.S. Cl. CPC H04R 1/326

(57) ABSTRACT

Disclosed in some examples are methods and systems for controlling an agricultural vehicle using audio signals captured by one or more microphones mounted on the vehicle. An example system includes a processing system configured to receive the audio signals from the one or more microphones, process the audio signals using one or more machine learning models to detect an abnormal condition, and based on the detection of the abnormal condition, generate a control command related to the abnormal condition. The system can further include an actuator system for receiving the control command and altering operation of the vehicle. The system can further include processing audio signals and sensor signals from other sensors on the vehicle (such as one or more of cameras, radar systems, and the like). The fusion of audio and non-audio data can in some examples better enable detection of the abnormal condition. The abnormal condition can be a verbal command, a verbal distress signal, a mechanical failure noise, an obstacle, a failure condition, a heavy engine load, and the like.

### CLAIM OF PRIORITY AND INCORPORATION BY REFERENCE

The present application claims the benefit under 35 U.S.C. § 119 (e) of U.S. Provisional Patent Application 63/599,833, filed Nov. 16, 2023, the disclosure of which is hereby incorporated by reference herein in its entirety.

### TECHNICAL FIELD

This document pertains generally, but not by way of limitation, to vehicle safety systems. Some embodiments relate to systems and methods for processing audio signals with microphones on an agricultural vehicle to detect and respond to abnormal conditions on or around a vehicle.

### BACKGROUND

Agricultural vehicles are large and complex and have many system components that can run in an automated fashion. For example, agricultural vehicles can have steering, braking and/or propulsion systems that run automatically based on GPS signals, guidance lines and other inputs. Other features of a vehicle (e.g., a tractor and/or implement) can operate automatically such as spraying and seeding systems. Safe and reliable operation of such vehicles is important.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an agricultural vehicle with microphones according to some examples of the present disclosure.

FIG. 2 illustrates an agricultural system using microphones according to some examples of the present disclosure.

FIG. 3 illustrates a flowchart of a method of operating an agricultural vehicle using audio obtained from microphones, according to some examples of the present disclosure.

FIG. 4 illustrates a flowchart of a method of operating an agricultural vehicle using audio obtained from microphones, according to some examples of the present disclosure.

FIG. 5 illustrates a machine learning engine for training and execution related to back side images in accordance with some embodiments.

FIG. 6 is a block diagram illustrating an example of a machine upon which one or more embodiments may be implemented.

### DETAILED DESCRIPTION

The inventors have recognized that it can be challenging to rely on radar signals or camera imaging to detect conditions around a vehicle such as an agricultural machine. These radar and imaging systems can suffer from processing challenges that can limit their effectiveness or increase their cost. The inventors have recognized that the operation of vehicles can be improved (e.g., increased safety, cost-effectiveness and/or reliability of vehicle operation) through the use of microphones which detect audio signals around the vehicle. The present disclosure provides techniques (e.g., systems and methods) for controlling an agricultural vehicle using audio signals captured by one or more microphones mounted on the vehicle. An example system includes a processing system configured to receive the audio signals from the one or more microphones, process the audio signals using one or more machine learning models to detect an abnormal condition, and based on the detection of the abnormal condition, generate a control command related to the abnormal condition. The abnormal condition can be a verbal command, a verbal distress signal, a mechanical failure noise, an obstacle, the sound of a heavy engine load, as examples. Control commands can be used to control actuators on the agricultural vehicle (e.g., main vehicle such as a tractor or an implement).

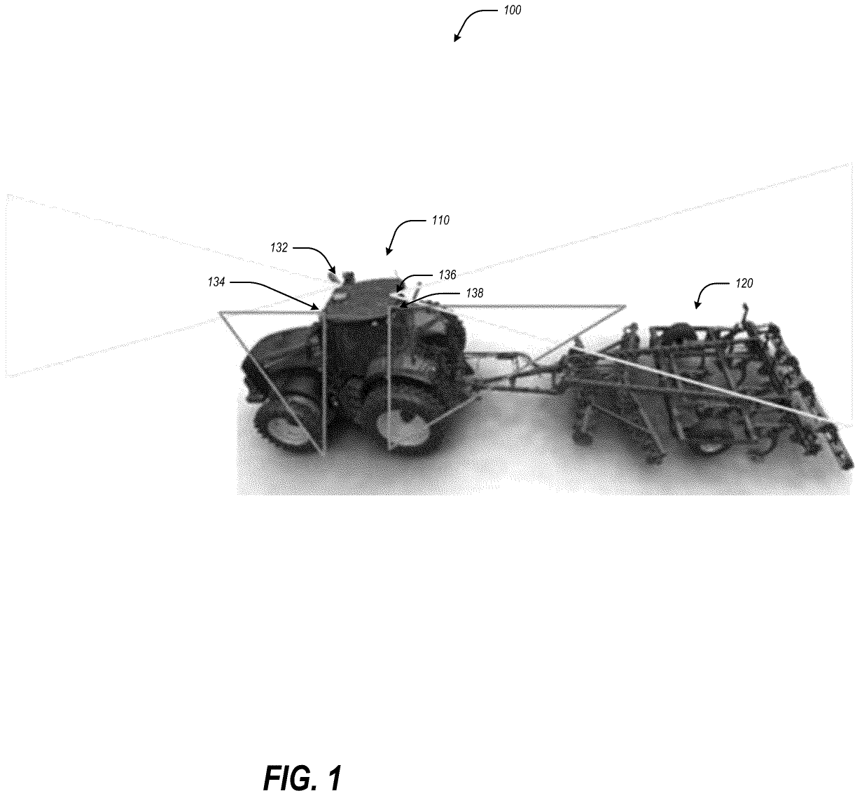

FIG. 1 illustrates an agricultural vehicle 100 with one or more microphones 132, 134, 136, 138 according to some examples of the present disclosure. The agricultural vehicle 100 includes a main vehicle, such as a tractor 110 for example, and an implement 120 towed by the tractor 110. The agricultural vehicle 100 is shown by way of example and not limitation; other vehicles can be used with the present disclosure, including prime movers, combines, harvesters, sprayers, planters, and the like, for example. The agricultural vehicle 100 includes four microphones 132-138 mounted on the tractor 110. In other examples, more or fewer (e.g., one or more) microphones can be used, and one or more microphones can be mounted on the implement 120 in addition to or in lieu of those mounted on the tractor 110. In the illustrated example, two microphones 132, 134 face forward in the direction of travel and two microphones 136, 138 face backwards. In other configurations, microphones can face in other directions. The microphones 132-138 capture sounds from the environment around the agricultural vehicle 100 and generate audio signals (e.g., analog or digital signals or data) representative of the detected sounds. The audio signals are in turn received by a computing system (e.g., a controller, computer, electronic control unit, or other processing circuitry, etc.) and used to detect abnormal conditions (e.g., commands, failure conditions, distress calls) on or around the agricultural vehicle 100. Some ways in which the audio signals can be used are described below.

The microphones 132-138 can be directional microphones such as ones suitable for outdoor applications. In some examples, any or all of the microphones 132-138 can be a stereo microphone having two stereo microphones in a single unit. Example microphones that can be used include Sennheiser microphones (e.g., the MKE 400 shotgun microphone and the Sennheiser MKE 440 stereo shotgun microphone), ETS microphones (e.g., the ETS ML1-WBE weather resistant, omni-directional microphone), and Zoom microphones (e.g., the H4n Pro microphone). Each microphone 132-138 can optionally be coupled to a camera for capturing images along with audio signals. The microphones 132-138 can be fixedly mounted on the main vehicle as illustrated. In other examples, one or more microphones 132-138 can be rotatably mounted on the main vehicle or the implement 120. Rotatable mounting can allow the microphone to be swiveled to facilitate the determination of the direction of the sound. The microphones 132-138 can be mounted on the top of the cab of the main vehicle, with each microphone 132-138 facing in a different direction. Top mounting of the microphones 132-138 can provide enhanced audio signal detection around the agricultural vehicle 100.

The frequency range of the microphones 132-138 can cover the frequency range of expected sounds (e.g., the human voice, equipment noises such engine noises, equipment noises, fluid noises, etc.). In some examples, each of the microphones has a frequency range covering the frequency range of expected sounds. In other examples, a first forward-facing microphones can have a first dynamic range (e.g., covering human voice) and a second forward-facing microphone can have a second dynamic range (e.g., covering equipment sounds). The rear-facing microphones can similarly be two different microphones covering different frequency ranges. In other examples, each microphone 132-138 can include two (or more) microphones with each covering a different frequency range (such as one for human voice and one for equipment sounds, for example).

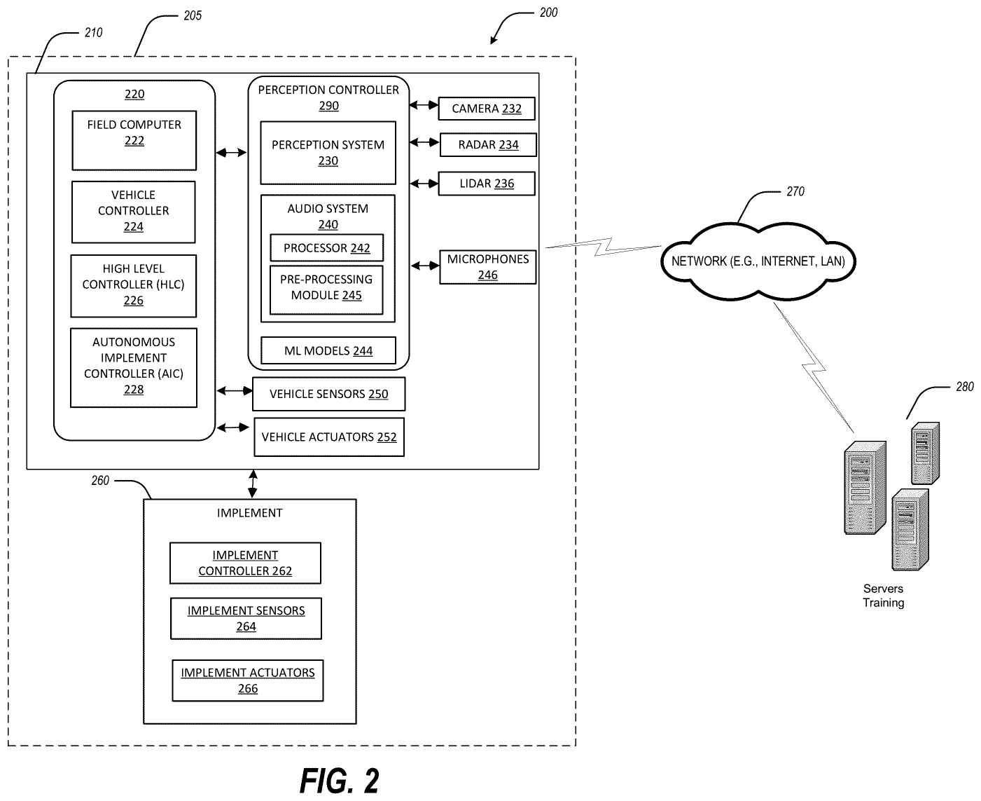

FIG. 2 illustrates an agricultural system 200 using one or more microphones 246 (e.g., directional microphones) according to some examples of the present disclosure. The agricultural system 200 includes an agricultural vehicle 205 that includes a main vehicle 210 (e.g., a tractor) and an optional implement 260. The agricultural system 200 further includes a remote computing system 280 (e.g., servers and/or workstations) for backend processing of data for the agricultural vehicle 205 and a network 270 communicatively connecting the agricultural vehicle 205 with the remote computing system 280. The network 270 can, for example include the internet or local area network (LAN). In other examples, the agricultural vehicle 205 may communicate with the remote computing system 280 using a direct communication technique (e.g., NFC, Wi-Fi direct, etc.) in addition to or instead of a network 270. The remote computing system 280 may be part of a computing system that handles other aspects of agricultural operations (e.g., vehicle tracking, vehicle guidance, vehicle dispatching, etc.) or may be standalone system interfacing with other remote computing systems. The remote computing system 280, as discussed further below, receive audio signals (e.g., from the agricultural vehicle 205, training data from other sources, etc.) and generate machine learning models that an agricultural vehicle can use to detect abnormal conditions on or around the vehicle.

The main vehicle 210 (e.g., a tractor) can include a processing system 220 (e.g., one or more computers, a control stack, etc.) which can in some examples include a field computer 222, a vehicle controller 224, a high-level controller (HLC) 226, and an autonomous implement controller (AIC) 228. Each of the field computer 222, vehicle controller 224, HLC 226, and AIC 228 can be a computing system including one or more processors and associated memory. Each of the field computer 222, vehicle controller 224, HLC 226, and AIC 228 can communicate with a perception system 230, an audio system 240, vehicle sensors 250, and vehicle actuators 252. Communication can take place over a CAN bus or other communications interface (e.g., wi-fi, cellular, Bluetooth, direct wired connections, etc.). The field computer 222 can, among other things, process information about the present field such as, but not limited to, field boundaries, crops, row spacing, zone prescriptions, indexed obstacles or the like. The vehicle controller 224 can, among other things, control operation of the agricultural vehicle 205 including controlling vehicle actuators 252 (e.g., steering, propulsion, and braking) or implement actuators 266. For example, the vehicle controller 224 can control steering actuators based on signals from vehicle sensors (e.g., GPS signals, yaw sensors, etc.) and field boundaries, etc. The vehicle controller 224 can, in some examples, autonomously or semi-autonomously control the agricultural vehicle 205. The high-level controller 226 can handle higher priority operations, for instance related to safety. The AIC 228 can autonomously control certain implement functions (e.g., task specific functions/routines for the implement) and provide commands to one or more ECUs on one or more implements to carry out. The field computer 222, vehicle controller 224, high level controller 226, and AIC 228 can operate on separate computing systems, as illustrated. In other examples, the functions of the field computer 222, vehicle controller 224, high level controller 226, and AIC 228 can be performed by a single computer or distributed across any number of computing systems.

The main vehicle 205 can include a perception controller 290 having a perception system 230 and an audio system 240. The perception controller 290 can be a computing system including one or more processors for performing its operations. The perception controller 290 can be coupled to one or more non-audio sensors such as one or more cameras 232, radar systems 234, lidar systems 236 and/or microphones 246. The perception system 230 can receive sensor signals from the camera, radar and/or lidar sensors 232-236 and detect obstacles and other conditions in the environment around the agricultural vehicle 205. The perception system 230 can provide data to the processing system 220 (e.g., vehicle controller, HLC, and/or AIC) which can act on the data by changing operation of the agricultural vehicle 205 (e.g., main vehicle and/or implement). For example, the perception system 230 can detect a human within 50 feet and prompt the high-level controller 226 to override operation and halt operation of the main vehicle 210. In another example, the perception system 230 can detect livestock or an obstacle having one or more dimensions above a dimensional threshold along a planned path of the main vehicle 210, provide data regarding this detection to the processing system 220 (e.g., vehicle controller, HLC and/or AIC), and the processing system 220) can send commands to an actuator system (e.g., one or more of vehicle actuators and/or controllers, implement actuators and or controllers) to, for example, halt operation of the main vehicle 210 or redirect the main vehicle 210 around the obstacle or adjust an implement (e.g., raise an implement section). The HLC 226 can for example send commands to the vehicle actuators 252 to stop the main vehicle 210 or the AIC 228 can send commands to the implement controller to change operation of the implement 260 (via commands to the implement actuators). The perception system 220 can be a computing system including one or more processors for performing its operations.

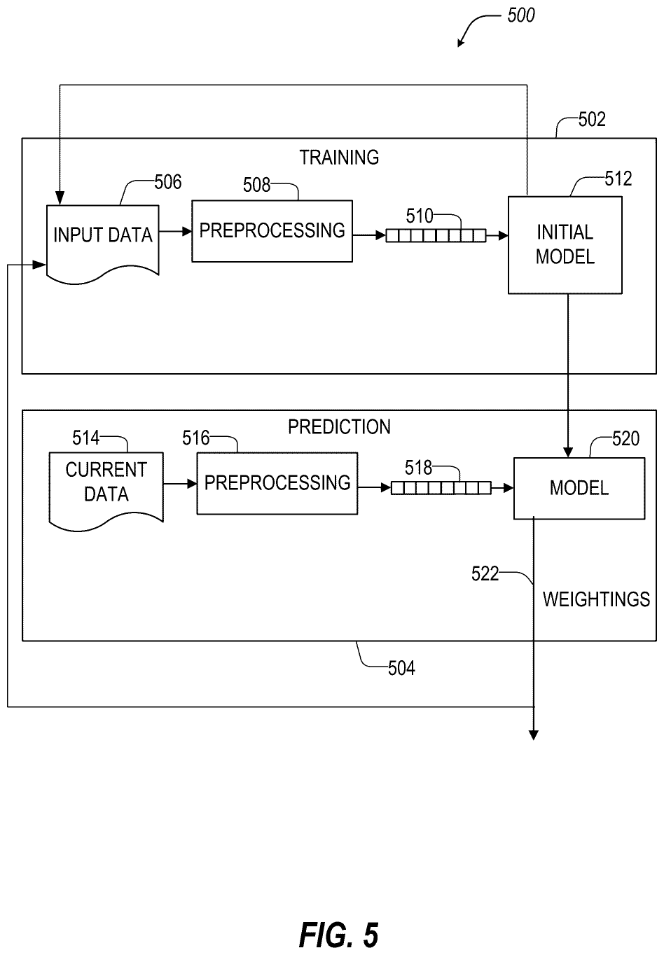

The audio system 240 can receive audio signals from the one or more microphones 246, detecting abnormal conditions, and providing output signals to the processing system 220 (e.g., the vehicle controller, HLC, or AIC). The microphones 246 can, for example, be directional microphones as discussed above. The audio system 240 can be a computing system that includes one or more processors 242 and memory for performing its functions. The audio system 240 can use (e.g., call or load) one or more machine learning (ML) models 244 (e.g., stored in memory) that can be used to detect abnormal conditions related to the agricultural vehicle 205 based on the audio signals received from the microphones 246. This can include abnormal conditions near the agricultural vehicle 205 (e.g., a distress signal or command from a nearby human) or abnormal conditions on the agricultural vehicle 205 (e.g., a failure of a tractor component or an implement component). FIG. 5 below and the related discussion provide details of an example ML engine, including training of an ML model and output of a ML model. The audio system 240 can further include a pre-processing module 245 for pre-processing (e.g., filtering, segmentation, featuring extraction, encoding, and the like) audio signals from the microphones 246 and generating pre-processed audio signals for use with the ML models 244. Pre-processing can be used, for example, to filter or remove noise and extract relevant features. This can improve analysis of the audio signals by ML models 244. The audio system 240 and perception system 230 can be subsystems of the perception controller 290 or, in other examples, can be standalone systems. In some examples, the perception controller can include only one of the audio system 240 or perception system 230.

The agricultural vehicle 205 can further include an agricultural implement 260. An example implement 260 can be a harvester head, a sprayer boom, a cultivator, a spreader, a seeder, a planter, a mower, a baler, a grain cart or the like. The implement 260 can further include an implement controller 262, implement actuators 266, and implement sensors 264. The implement controller 262 can, for example, be a computing system such as an electronic control unit (ECU) and can be mounted on the implement itself. The implement controller 272 can receive sensor signals from the implement sensors 264 and, based on the sensor signals, provide instructions to the implement actuators 266 for controlling the implement actuators 266 during an agricultural operation. In an example, the implement controller 262 is a lower priority controller relative to the main vehicle processing system 220. For example, a control command for an implement actuator 266 from the vehicle controller 224, high level controller 226 or AIC 228 can override a control command for that actuator from the implement controller 262. The implement sensors 264 can vary depending on the type of implement and can include, for example, one or more cameras, radar systems, lidar systems, pressure sensors, flow sensors, etc. Likewise, the implement actuators 266 can vary depending on the type of implement and can include, for example, boom hydraulics, implement steering mechanisms, nozzle valve actuators, etc. Agricultural vehicle as used herein can refer to a main vehicle, an implement, or a main vehicle-implement combination. Sensor signals and actuator commands can be communicated to and from each of the components of the agricultural vehicle 205 including the optional implement 260 to enable operation of agricultural vehicle, including fully or semi-autonomous operation.

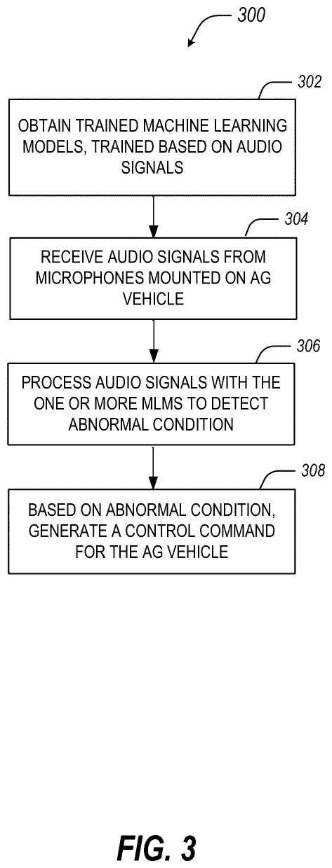

FIG. 3 illustrates a flowchart of a method 300 of operating an agricultural vehicle using audio signals obtained from microphones, according to some examples of the present disclosure. The method 300 includes obtaining one or more trained machine learning models that are trained based on audio signals (e.g., sounds of an agricultural environment, sounds of verbal commands, sounds of distress, sounds of component failures, etc.) as indicated at block 302. This may include receiving the machine learning models from a remote computing system. The machine learning models can be generated using the techniques described herein (e.g., in connection with FIG. 5). In some examples, the agricultural vehicle identifies itself to a remote server which then sends one or more MLMs to the agricultural vehicle based on its identification (e.g., type of vehicle).

At block 304, the method 300 includes receiving audio signals from one or more microphones mounted on an agricultural vehicle (e.g., mounted on a main vehicle and/or associated implement). The microphones can be directional microphones, with one or more microphones facing rearwardly and one or more facing forwardly. Receiving signals can include receiving audio signals generated by the microphones while the vehicle is operating, before a vehicle starts, or after a vehicle stops.

At block 306, the method includes processing audio signals with one or more machine learning models to detect an abnormal condition. Prior to processing the audio signals with the MLMs, the method 300 can include pre-processing the audio signals to filter the signals, remove noise, extract features, and the like, and then providing the pre-processed audio signals to the MLM's. Processing audio signals with the MLMs can further include selecting one or more of the MLMs for processing the audio signals. For example, a user can select from among a set of MLMs which MLMs to use. In other examples, the agricultural vehicle can automatically select the one or more MLMs to use, for example, based on a detected operating condition. In some examples, a single MLM is used to detect an abnormal condition and in other examples, multiple MLMs can be used. Multiple MLM's can provide redundancy and allow for more accurate detection in some instances. Processing audio signals with MLMs can further include outputting a signal indicating an abnormal condition. The signal can for example include a condition type (e.g., a distress signal, a malfunction, a command, etc.) and a confidence level. The output signal can be provided to a main vehicle processing system such as system 220 (e.g., vehicle controller, HLC, and/or AIC) shown in FIG. 2.

At block 308, the method 300 includes generating a control command based on the abnormal condition. The control command can be generated by a processing system such as a vehicle controller, a high-level controller and/or AIC and can control an actuator of the main vehicle or an associated implement. In some examples, generating a control command includes is based on the condition type and its confidence level as compared to a threshold. For example, a distress signal condition type can trigger a stop command based on a lower threshold confidence level; whereas a heavy engine load condition type can require a higher confidence level to trigger an actuator command.

In one example, the perception controller 290 can, for example, receive audio signals from one or more microphones 246 and non-audio signals from other sensors, such as cameras 232, radar system 234, lidar system 236, vehicle sensors 250, and implement sensors (not shown). Using one more MLMs 244 (move outside of audio system) trained on audio signals and other non-audio sensor signals, the perception controller 290 can detect abnormal conditions and provide a signal to the processing system 220 (e.g., vehicle controller, HLC, and/or AIC) which can provide commands to vehicle or implement actuators based on the detected condition. In other examples, the perception controller 290 can correlate output signals from the audio system 240 (e.g., based on microphone signals) and output signals from the perception system 230 (e.g., based on camera, lidar, and/or radar signals), and output a fused detection signal to the vehicle processing system 220. For example, the audio system 240 can output a detection signal indicating an abnormal condition, a confidence level and a time stamp, and the perception system 230 can output a signal indicating one or more of a type of obstacle, dimension of obstacle, location of obstacle, confidence level of the obstacle, and timing stamp. Based on the detection signals for the condition and the obstacle, the perception controller 290 can correlate the two based on the time stamps and provide an abnormal condition detection signal to the processing system 220. In another example, the perception controller 290 can store a bubble region (e.g., an area or distance around the vehicle) and the perception controller 290 can detect an abnormal condition when a detected event occurs within the bubble region. The bubble region can be set by a user, be a factory preset condition, or be received by a remote computing system, for example. In some examples, the audio system 240 can detect an event (based on audio signals) and a determine a distance of the event from the vehicle and can determine an abnormal condition when the detected audio event distance occurs within the bubble region. In some examples, the perception system 230 can detect an event (based on camera, radar, and/or lidar) and a determine a distance of the event from the vehicle and can determine an abnormal condition when the detected non-audio event distance occurs within the bubble region. The audio system 240 and the perception system 230 can use the same bubble region or can be provided with different bubble regions.

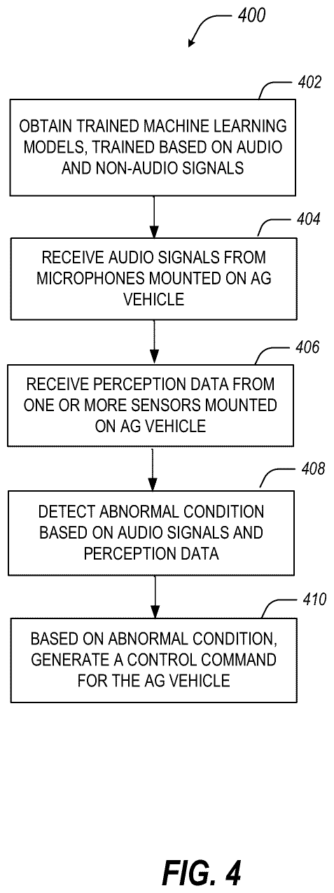

FIG. 4 illustrates a flowchart of a method 400 of operating an agricultural vehicle using audio signals and non-audio signals, according to some examples of the present disclosure. The method 400 includes obtaining one or more trained machine learning models that are trained based audio signals and non-audio signals that can be encountered in an agricultural, as indicated at block 402. In this example, the MLMs can be trained on audio signals (e.g., from microphones) and non-audio signals (e.g., image data from a camera, radar data, or lidar data, vehicle or implement sensor signals, are any combination thereof). This may include receiving the machine learning models from a remote computing system. The machine learning models can be generated using the techniques described herein (e.g., in connection with FIG. 5). In some examples, the agricultural vehicle identifies itself to a remote server which then sends one or more MLMs to the agricultural vehicle based on its identification (e.g., type of vehicle),

At block 404, the method 400 includes receiving audio signals from microphones mounted on an agricultural vehicle (e.g., mounted on a main vehicle and/or associated implement). The audio signals can be received by a fusion system from one or more directional microphones or other microphones mounted on an agricultural vehicle (e.g., a main vehicle and/or implement). Receiving audio signals can be done in a similar manner as discussed above. At block 406, the method 400 includes receiving non-audio signals from one or more sensors associated with the vehicle. This can include receiving, by a fusion system, image data, radar data, lidar data, GPS data, yaw sensor signals, pressure data, flow data, etc. from sensors on the vehicle and/or an associated implement. Receiving of non-audio signals and audio signals can occur at the same or different times.

At block 408, the method includes processing the received audio signals and non-audio signals with the one or more machine learning models to detect an abnormal condition. Prior to processing the audio signals with the MLMs, the method 400 can include pre-processing the audio signals and/or non-audio signals to filter the signals, remove noise, extract features, and the like, and then providing the pre-processed signals to the MLM's. Processing audio and non-audio signals with the MLMs can further include selecting one or more of the MLMs for processing the signals. For example, a user can select from among a set of MLMs which MLMs to use. In other examples, the agricultural vehicle can automatically select the one or more MLMs to use, for example, based on a detected or commanded operating condition. In some examples, a single MLM is used to detect an abnormal condition and in other examples, multiple MLMs can be used. Multiple MLM's can provide redundancy and allow for more accurate detection of abnormal conditions in some instances. Processing audio and non-audio signals with MLMs can further include outputting a signal indicating an abnormal condition. The signal can for example include a condition type (e.g., a distress signal, a malfunction, etc.) and a confidence level. The output signal can be provided to a main vehicle processing system such as processing system 220 shown in FIG. 2.

At block 410, the method 400 includes generating a control command based on the abnormal condition. The control command can be generated by the processing system such as a vehicle controller, a high level controller and/or AIC and can control an actuator of the main vehicle or an associated implement. In some examples, generating a control command includes is based on the condition type and its confidence level as compared to a threshold. For example, a distress signal condition type can trigger a stop command based on a lower threshold confidence level; whereas a heavy engine load condition type can require a higher confidence level to trigger an actuator command.

The above systems can be used to detect a wide variety of abnormal conditions that can facilitate the operation, safety, and/or reliability of an agricultural vehicle. In one example, a person near an agricultural vehicle can yell a distress signal (such as help or stop or scream) or issue a command (e.g., stop, turn left, turn right) which can be detected by a microphone and processed by an audio system (or audio fusion system) using one or more MLMs to detect the abnormal condition (e.g., distress signal or verbal command). Based on the detected distress signal, the vehicle processing system (e.g., vehicle controller or HLC) can issue control commands to brake the vehicle, shut off any components, steer the vehicle, etc. In another example, the vehicle can hit a rock, detect the sound of the rock impact, and detect the rock hit as an abnormal condition using one or more MLMs. This abnormal condition can be stored in memory and used to increase a confidence level of a later detected abnormal condition based on vehicle performance. For example, if after detecting a rock hit, an engine noise abnormal condition is detected, the confidence level of the condition can be increased based on the prior detected rock hit within a certain timeframe. In another example, a component such as a hose can break causing fluid (e.g., water, coolant, engine oil or hydraulic oil) to spray and the audio system can detect the water spray sounds and detect this as an abnormal condition using MLMs. In some examples, a fusion system can receive audio signals from the water sounds and image data of the water spray, and using MLMs, detect a hose break as an abnormal condition. Based on the hose break condition, the vehicle processing system (e.g., vehicle controller or HLC) can issue commands such as alerting an operator of the hose break, shutting off valves or water supply to the hose, and/or braking and turning off the vehicle. In another example, an audio or fusion system can detect sounds associated with engine load, and using MLMs trained on normal and abnormal engine loads, an abnormal engine load condition can be detected and a signal provided to the vehicle processing system (e.g., vehicle controller or HLC) which can in turn issue commands to slow down or stop the vehicle, or turn the vehicle or move an implement to clear a clog or other condition that can be causing the increased load on the engine.

FIG. 5 illustrates a machine learning engine for training and execution related to detecting abnormal conditions using audio signals from microphones mounted on an agricultural vehicle in accordance with some embodiments. In one example, a machine learning engine may be used to detect (e.g., determine, classify, etc.) an abnormal condition such as a distress signal from a nearby person, a command from a nearby vehicle operator, a failure of a component of the vehicle such as a hose or a tire, the sound of a heavy engine load above a threshold, etc. The machine learning (ML) engine can be deployed to execute on a processor on the vehicle (e.g., on an audio system and/or a perception system as shown in FIG. 2) and/or on a remote computing system (e.g., a remote computing system as shown in FIG. 1). A system may calculate one or more weightings for criteria based upon one or more machine learning algorithms. FIG. 5 shows an example machine learning engine 500 according to some examples of the present disclosure.

Machine learning engine 500 utilizes a training engine 502 and a prediction engine 504. Training engine 502 uses input data 506, after undergoing preprocessing component 508, to determine one or more features 510. The one or more features 510 may be used to generate an initial model 512, which may be updated iteratively or with future unlabeled data. The input data 506 may include audio recordings of a representative vehicle operating in a field, audio signals representative of distress calls, audio signals representative of verbal commands, audio signals representative of vehicle (including implement) failures such as blown hoses, heavy engine loads, etc. In other examples, where fusion is used, the input data can further include radar, lidar, and/or camera images and objects and other conditions associated with the data from these other sensors. In yet other examples, other vehicle sensor signals such as pump pressure sensors, tire pressure sensors, yaw sensors, etc. can be used.

In the prediction engine 504, current data 514 may be input to preprocessing component 516. In some examples, preprocessing component 516 and preprocessing component 508 are the same. The prediction engine 504 produces feature vector 518 from the preprocessed current data, which is input into the model 520 to generate one or more criteria weightings 522. The criteria weightings 522 may be used to output a prediction, as discussed further below. The current data 514 may include audio signals from microphones mounted on an agricultural vehicle as it operates in a field. In other examples, where fusion is used, the input data can further include radar, lidar, and/or image data or data from other vehicle sensors.

The training engine 502 may operate in an offline manner to train the model 520 (e.g., on a server). The prediction engine 504 may be designed to operate in an online manner (e.g., in real-time, on a vehicle, on a perception controller, on a remote computing system, etc.). In other examples, the training engine 502 may operate in an online manner (e.g., in real-time, on a vehicle, on a perception controller, on a remote computing system, etc.). In some examples, the model 520 may be periodically updated via additional training (e.g., via updated input data 506 or based on labeled or unlabeled data output in the weightings 522) or feedback (e.g., feedback from vehicle operators or remote computing system users.). The initial model 512 may be updated using further input data 506 until a satisfactory model 520 is generated. The model 520 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 502 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 502. In an example embodiment, a regression model is used and the model 520 is a vector of coefficients corresponding to a learned importance for each of the features in the vector of features 510, 518. Once trained, the model 520 may output a signal indicating detection of an abnormal condition related (e.g., on or near) to the agricultural vehicle. In some examples, the model 520 can indicate one or more specific types of conditions and a confidence value associated with each (e.g., a value indication of the probability the detected condition is true).

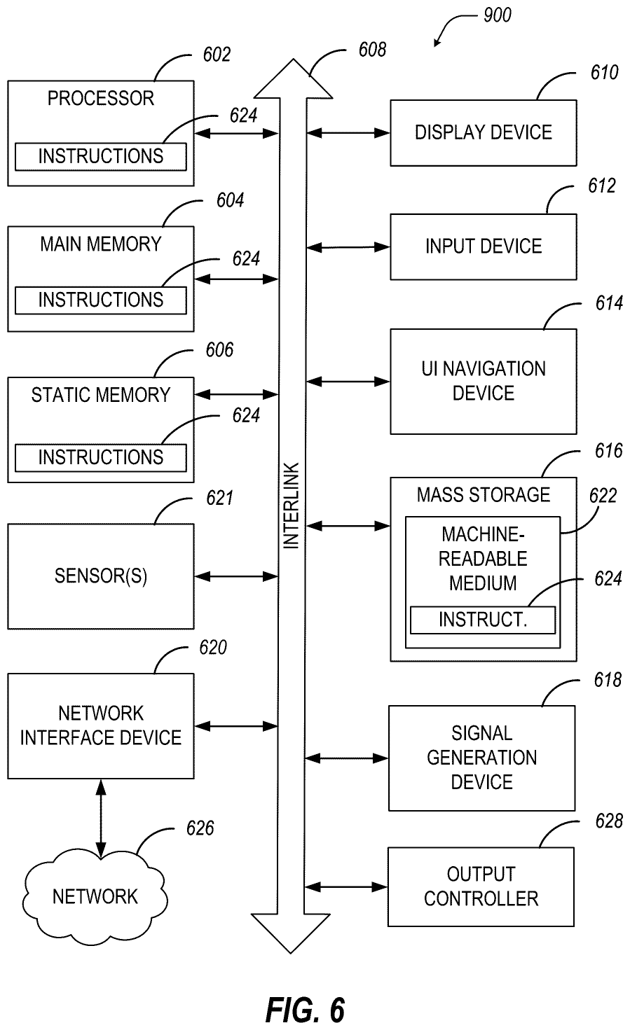

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. For example, a machine 600 may be a server running at an issuing bank. Similarly, a machine 600 may be configured to implement the functionality of a payment identification component, a recurring transaction component, and/or a notification component or the like. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine-readable medium. In an example, the software, when executed by the underlying hardware of the component, causes the hardware to perform the specified operations.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Machine (e.g., computing system) 600 may include a hardware processor 602 (e.g., a central processing unit (CPU), a graphics processing unit (GPU), a hardware processor core, or any combination thereof), a main memory 604 and a static memory 609, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 619, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine-readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 609, or within the hardware processor 602 during execution thereof by the machine 600. In an example, one or any combination of the hardware processor 602, the main memory 604, the static memory 609, or the storage device 619 may constitute machine-readable media.

While the machine-readable medium 622 is illustrated as a single medium, the term “machine-readable medium” may include a single medium or multiple media (e.g., a centralized or distributed database, and/or associated caches and servers) configured to store the one or more instructions 624.

The term “machine-readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine-readable media. In some examples, machine-readable media may include machine-readable media that is not a transitory propagating signal.

The instructions 624 may further be transmitted or received over a communications network 629 using a transmission medium via the network interface device 620. The Machine 600 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.19 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 629. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### VARIOUS NOTES AND EXAMPLES

Example 1 is an agricultural vehicle control system, comprising: one or more microphones mounted on an agricultural vehicle and configured to detect sounds around the vehicle and generate audio signals representative of the detected sounds; a processing system, including a processor and a memory, configured to: receive the audio signals from the one or more microphones; process the audio signals using a machine learning model to detect an abnormal condition related to the agricultural vehicle; and based on the detection of the abnormal condition, generate a control command for a vehicle actuator or implement actuator that is related to the abnormal condition.

In Example 2, the subject matter of Example 1 optionally includes wherein the one or more microphones includes at least two directional microphones facing in different directions.

In Example 3, the subject matter of any one or more of Examples 1-2 optionally include wherein the one or more microphones includes at least four directional microphones facing in different directions.

In Example 4, the subject matter of any one or more of Examples 1-3 optionally include wherein the processing system includes a pre-processing module for pre-processing the audio signals and wherein processing the audio signals includes processing the pre-processed audio signals.

In Example 5, the subject matter of Example 4 optionally includes wherein the pre-processing module filters the audio signals.

In Example 6, the subject matter of any one or more of Examples 1-5 optionally include one or more non-audio sensors mounted on the vehicle for sensing conditions on or around the vehicle and generating non-audio signals, wherein the processing system is configured to: receive the audio signals from the one or more microphones and the non-audio signals from the one or more non-audio sensors; and process the audio signals and the non-audio signals using the machine learning model to detect the abnormal condition.

In Example 7, the subject matter of Example 6 optionally includes wherein the one or more non-audio sensors includes at least one of a camera, a radar system, a lidar system, or a combination thereof.

In Example 8, the subject matter of Example 7 optionally includes wherein processing the audio signals and the non-audio signals includes correlating a time of the audio signals with a time of the non-audio signals.

In Example 9, the subject matter of any one or more of Examples 1-8 optionally include wherein the machine learning model includes a trained machine learning model.

In Example 10, the subject matter of any one or more of Examples 1-9 optionally include an actuator system configured to receive the control command and alter operation of the vehicle actuator or the implement actuator based on the control command.

Example 11 is a method of controlling an agricultural vehicle, comprising: obtaining, with a processing system, one or more machine learning models trained using sounds from a representative agricultural machine; receiving, with the processing system, audio signals detected by one or more microphones mounted on the agricultural vehicle; processing, with the processing system, the audio signals using the one or more machine learning models to detect an abnormal condition; and based on the detection of the abnormal condition, generating, with the processing system, a control command for the agricultural vehicle related to the abnormal condition.

In Example 12, the subject matter of Example 11 optionally includes wherein the one or more microphones includes at least two directional microphones facing in different directions.

In Example 13, the subject matter of any one or more of Examples 11-12 optionally include wherein the one or more microphones includes at least four directional microphones facing in different directions.

In Example 14, the subject matter of any one or more of Examples 11-13 optionally include wherein processing the audio signals includes pre-processing the audio signals.

In Example 15, the subject matter of Example 14 optionally includes wherein the pre-processing includes filtering the audio signals.

In Example 16, the subject matter of any one or more of Examples 11-15 optionally include providing one or more non-audio sensors mounted on the vehicle for sensing conditions on or around the vehicle and generating non-audio signals, wherein the method includes: receiving the audio signals from the one or more microphones and the non-audio sensor signals from the one or more non-audio sensors; and processing the audio signals and the non-audio sensor signals using the one or more machine learning models to detect the abnormal condition.

In Example 17, the subject matter of Example 16 optionally includes wherein the one or more non-audio sensors includes at least one of a camera, a radar system, a lidar system, or a combination thereof.

In Example 18, the subject matter of Example 17 optionally includes wherein the one or more machine learning models includes a trained model trained on audio data and non-audio data.

In Example 19, the subject matter of any one or more of Examples 17-18 optionally include wherein processing the audio signals and the non-audio signals includes correlating a time of the audio signals with a time of the non-audio signals.

In Example 20, the subject matter of any one or more of Examples 11-19 optionally include receive the control command with an actuator system and altering operation of the vehicle based on the control command.

### ADDITIONAL NOTES

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An agricultural vehicle control system, comprising:
one or more microphones mounted on an agricultural vehicle and configured to detect sounds around the agricultural vehicle and generate audio signals representative of the detected sounds; and
a processing system, including a processor and a memory, configured to:
receive the audio signals from the one or more microphones;
process the audio signals using a machine learning model to detect an abnormal condition related to the agricultural vehicle; and
based on the detection of the abnormal condition, generate a control command for a vehicle actuator or implement actuator that is related to the abnormal condition.

2. The agricultural vehicle control system of claim 1, wherein the one or more microphones includes at least two directional microphones facing in different directions.

3. The agricultural vehicle control system of claim 1, wherein the one or more microphones includes at least four directional microphones facing in different directions.

4. The agricultural vehicle control system of claim 1, wherein the processing system includes a pre-processing module for pre-processing the audio signals and wherein processing the audio signals includes processing the pre-processed audio signals.

5. The agricultural vehicle control system of claim 4, wherein the pre-processing module filters the audio signals.

6. The agricultural vehicle control system of claim 1, further including one or more non-audio sensors mounted on the agricultural vehicle for sensing conditions on or around the agricultural vehicle and generating non-audio signals, wherein the processing system is configured to:
receive the non-audio signals from the one or more non-audio sensors; and
process the audio signals and the non-audio signals using the machine learning model to detect the abnormal condition.

7. The agricultural vehicle control system of claim 6, wherein the one or more non-audio sensors includes at least one of a camera, a radar system, a lidar system, or a combination thereof.

8. The agricultural vehicle control system of claim 7, wherein processing the audio signals and the non-audio signals includes correlating a first time of the audio signals with a second time of the non-audio signals.

9. The agricultural vehicle control system of claim 1, wherein the machine learning model includes a trained machine learning model.

10. The agricultural vehicle control system of claim 1, further including an actuator system configured to receive the control command and alter operation of the vehicle actuator or the implement actuator based on the control command.

11. A method of controlling an agricultural vehicle, comprising:
obtaining, with a processing system having one or more processors and a memory, one or more machine learning models trained using sounds from a representative agricultural machine;
receiving, with the processing system, audio signals detected by one or more microphones mounted on the agricultural vehicle;
processing, with the processing system, the audio signals using the one or more machine learning models to detect an abnormal condition; and
based on the detection of the abnormal condition, generating, with the processing system, a control command for the agricultural vehicle related to the abnormal condition.

12. The method of claim 11, wherein the one or more microphones includes at least two directional microphones facing in different directions.

13. The method of claim 11, wherein the one or more microphones includes at least four directional microphones facing in different directions.

14. The method of claim 11, wherein processing the audio signals includes pre-processing the audio signals.

15. The method of claim 14, wherein pre-processing includes filtering the audio signals.

16. The method of claim 11, further including providing one or more non-audio sensors mounted on the agricultural vehicle for sensing conditions on or around the agricultural vehicle and generating non-audio signals, wherein the method includes:
receiving, with the processing system, the non-audio signals from the one or more non-audio sensors; and
processing the audio signals and the non-audio signals using the one or more machine learning models to detect the abnormal condition.

17. The method of claim 16, wherein the one or more non-audio sensors includes at least one of a camera, a radar system, a lidar system, or a combination thereof.

18. The method of claim 17, wherein the one or more machine learning models includes a trained model trained on audio data and non-audio data.

19. The method of claim 17, wherein processing the audio signals and the non-audio signals includes correlating a first time of the audio signals with a second time of the non-audio signals.

20. The method of claim 11, further including receiving the control command with an actuator system and altering operation of the agricultural vehicle based on the control command.
